(19) United States
(12) Patent Application Publication
(10) Pub. No.: US 2016/0112710 A1
(43) Pub. Date: Apr. 21, 2016

(54) DECODER, APPLICATION PROCESSOR INCLUDING THE DECODER, AND METHOD OF OPERATING THE DECODER

(71) Applicant: SAMSUNG ELECTRONICS CO., LTD., Suwon-si (KR)

(72) Inventors: Hyeon Su PARK, Yongin-si (KR); Nyeong Kyu KWON, Daejeon (KR)

(73) Assignee: SAMSUNG ELECTRONICS CO., LTD., Suwon-si (KR)

(21) Appl. No.: 14/829,765

(22) Filed: Aug. 19, 2015

(30) Foreign Application Priority Data
Oct. 17, 2014 (KR) 10-2014-0140918

(51) Int. Cl. H04N 19/25; H04N 19/172; H04N 19/44; H04N 19/184

(52) U.S. Cl. CPC H04N 19/25; H04N 19/184; H04N 19/172; H04N 19/44

(57) ABSTRACT

A decoder is provided. The decoder includes a cadence detector configured to determine whether a video stream is a pull-down stream, and remove at least one duplicate frame from the video stream, in response to determining the video stream is the pull-down stream; and a decoding module configured to decode the video stream and output decoded frames of the video stream.

### CROSS-REFERENCE TO RELATED APPLICATION

This application claims priority from Korean Patent Application No. 10-2014-0140918, filed on Oct. 17, 2014, in the Korean Intellectual Property Office, the disclosure of which is incorporated herein in its entirety by reference.

### BACKGROUND

1. Field

One or more exemplary embodiments relate to a decoder, an application processor including the decoder, and a method of operating the decoder, and more particularly, to a decoder capable of minimizing post-processing calculation and the occurrence of errors, an application processor including the decoder, and a method of operating the decoder.

2. Related Art

Generally, a video signal is compressed into encoded data before it is transmitted to a receiver. In addition, the encoded data is generated according to a compression format and transmitted to the receiver. In order to reproduce the encoded data, the receiver decodes the encoded data that is received in the form of a bitstream.

In order to comply with broadcasting standards of each country, the frame rate of the encoded data may be converted into a frame rate according to the different broadcasting standards. For example, the National Television System Committee (NTSC) or the Advanced Television Standards Committee (ATSC), which are analog or digital broadcasting standards employed in Korea, USA, Japan, etc. require video to be presented at 60 frames per second (fps). Thus, the frame rate of the encoded data should be converted into a 60 fps video.

In order to achieve a 60 fps video, frames may be added to on the decoding side. However, the addition of frames when the receiving side decodes the encoded data may cause unnecessary arithmetic operations to be performed and/or generate errors.

### SUMMARY

Exemplary embodiments provide a decoder capable of decreasing unnecessary arithmetic operations and errors by removing duplicate frames before post processing, an application processor including the decoder, and a method of operating the decoder.

According to an aspect of an exemplary embodiment, a decoder includes a cadence detector configured to determine whether a video stream is a pull-down stream, and remove at least one duplicate frame from the video stream, in response to determining that the video stream is the pull-down stream, and a decoding module configured to decode the video stream at a front end of the cadence detector or an output stream of the cadence detector at a back end of the cadence detector.

The cadence detector may include a frame comparator configured to generate a comparison result by comparing consecutive frames of the video stream with each other, a frame attribute determiner configured to generate a determination result by determining whether the consecutive frames correspond to the pull-down stream, based on the comparison result, and a duplicate frame remover configured to selectively remove the at least one duplicate frame from the consecutive frames, based on the determination result.

The duplicate frame remover may bypass the consecutive frames when the consecutive frames do not include the at least one duplicate frame.

The frame attribute determiner may generate cadence format information regarding a pull-down ratio, based on the determination result.

The frame attribute determiner may generate scene change detection information regarding a change in the consecutive frames, based on the comparison result.

When the decoding module decodes the video stream at the front end of the cadence detector, the cadence detector may output, to a post-processor, an original stream obtained by selectively removing the at least one duplicate frame from the decoded video stream, cadence format information regarding a pull-down ratio, and scene change detection information regarding a change in consecutive frames of the video stream.

When the decoding module decodes the video stream at the back end of the cadence detector, the cadence detector may transmit, to the decoding module, the output stream obtained by selectively removing the at least one duplicate frame from the video stream, cadence format information regarding a pull-down ratio, and scene change detection information regarding a change in consecutive frames of the video stream, and the decoding module may decode the output stream, based on the cadence format information and the scene change detection information.

According to an aspect of another exemplary embodiment, an application processor includes a decoder configured to decode a video stream and generate a decoded video stream by selectively removing at least one duplicate frame from the video stream, and a post-processor configured to post-process the decoded video stream. The post-processor may include: a frame rate conversion unit configured to convert the original decoded video stream into a stream having a predetermined frame rate, and a digital image stabilization unit configured to perform image stabilization on the original decoded video stream.

The decoder may include a cadence detector configured to determine whether the video stream is a pull-down stream, and to selectively remove the at least one duplicate frame from the video stream, in response to determining that the video stream is the pull-down stream, and a decoding module configured to decode the video stream at a front end of the cadence detector or an output stream of the cadence detector at a back end of the cadence detector.

The cadence detector may include a frame comparator configured to generate a comparison result by comparing consecutive frames of the video stream with each other, an frame attribute determiner configured to generate a determination result by determining whether the consecutive frames correspond to a pull-down stream, based on the comparison result, and a duplicate frame remover configured to selectively remove the at least one duplicate frame from the consecutive frames, based on the determination result.

The duplicate frame remover may bypass the consecutive frames when the consecutive frames do not include the at least one duplicate frame.

The frame attribute determiner may generate cadence format information regarding a pull-down ratio, based on the determination result.

The frame attribute determiner may generate scene change detection information regarding a change in the consecutive frames, based on the comparison result.

When the decoding module decodes the video stream at the front end of the cadence detector, the cadence detector may output, to a post-processor, an original stream obtained by selectively removing the at least one duplicate frame from the decoded video stream, cadence format information regarding a pull-down ratio, and scene change detection information regarding a change in consecutive frames of the video stream.

When the decoding module decodes the video stream at the back end of the cadence detector, the cadence detector may transmit, to the decoding module, the output stream obtained by selectively removing the at least one duplicate frame from the video stream, cadence format information regarding a pull-down ratio, and scene change detection information regarding a change in consecutive frames of the video stream, and the decoding module may decode the output stream, based on the cadence format information and the scene change detection information, and output, to the post-processor, original stream obtained by decoding the output stream.

The post-processor may include a frame rate conversion unit configured to convert the original stream into a stream having a predetermined frame rate and a digital image stabilization unit configured to perform image stabilization on the original stream.

According to an aspect of another exemplary embodiment, a method of operating a decoder includes determining whether a video stream is a pull-down stream and removing at least one duplicate frame from the video stream by using a cadence detector, in response to determining that the video stream is the pull-down stream, and decoding the video stream at a front end of the cadence detector or an output stream of the cadence detector at a back end of the cadence detector.

The determining of whether the video stream is a pull-down stream and the removing of the at least one duplicate frame may include generating a comparison result by comparing consecutive frames of the video stream with each other, generating a determination result by determining whether the consecutive frames correspond to a pull-down stream, based on the comparison result, and selectively removing the at least one duplicate frame from the consecutive frames, based on the determination result.

The determining of whether the video stream is a pull-down stream and the removing of the at least one duplicate frame may further include generating cadence format information regarding a pull-down ratio, based on the determination result.

The determining of whether the video stream is a pull-down stream and the removing of the at least one duplicate frame may further include generating scene change detection information regarding a change in the consecutive frames, based on the comparison result.

According to an aspect of another exemplary embodiment, a decoder is provided. The decoder includes a cadence detector comprising a frame comparator, a frame attribute determiner, and a duplicate frame remover, and a decoding module configured to decode a video stream, wherein: the frame comparator is configured to generate a comparison result by comparing consecutive frames of a video stream with each other, the frame attribute determiner is configured to generate a determination result by determining whether the consecutive frames correspond to the pull-down stream, based on the comparison result, and the duplicate frame remover is configured to selectively remove the at least one duplicate frame from the consecutive frames, based on the determination result.

The duplicate frame remover may bypass the consecutive frames when the consecutive frames do not include the at least one duplicate frame.

The frame attribute determiner may generate cadence format information about a pull-down ratio, based on the determination result.

The frame attribute determiner may generate scene change detection information about a change of a scene in the consecutive frames, based on the comparison result.

### BRIEF DESCRIPTION OF THE DRAWINGS

Exemplary embodiments will be more clearly understood from the following detailed description taken in conjunction with the accompanying drawings in which:

FIG. 1 is a block diagram of a decoding system according to an exemplary embodiment;

FIG. 2 is a detailed block diagram of the decoding system of FIG. 1 according to an exemplary embodiment;

FIG. 3 is a detailed block diagram of the decoding system of FIG. 1 according to another exemplary embodiment;

FIG. 4 is a diagram illustrating an operation of the decoding system of FIG. 2 or FIG. 3 according to an exemplary embodiment;

FIG. 5 is a flowchart of a method of operating a decoder of FIG. 1 according to an exemplary embodiment; and

FIG. 6 is a detailed flowchart of an operation of a cadence detector of FIG. 2 or FIG. 3 according to an exemplary embodiment.

### DETAILED DESCRIPTION OF THE EXEMPLARY EMBODIMENTS

Exemplary embodiments now will be described more fully hereinafter with reference to the accompanying drawings. The exemplary embodiments may, however, be embodied in many different forms and should not be construed as limited to the exemplary embodiments set forth herein. Rather, these exemplary embodiments are provided so that this disclosure will be thorough and complete, and will fully convey the scope to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular exemplary embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

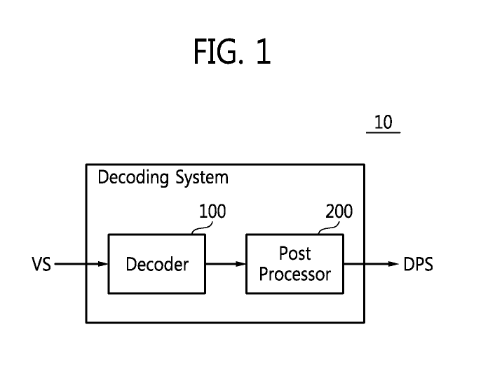

FIG. 1 is a block diagram of a decoding system 10 according to an exemplary embodiment.

Referring to FIG. 1, the decoding system 10 may be embodied as a part of a set-top box, a DVD player, an MP3 player, a smartphone, etc. The decoding system 10 is capable of restoring and/or processing a video stream VS, which is a digital compression signal of the original video signal. The decoding system 10 may be an application processor.

The video stream VS includes a plurality of pieces of data that are sequentially transmitted in units of bits and encoded in a standard compression format, e.g., MPEG-4, WMV, DivX, H.264, etc. The video stream VS may be received from the outside of the decoding system 10, e.g., a memory of a smartphone or a video server connected to the decoding system 10 via a digital network. The video stream VS may include a plurality of frames that are predetermined bit units, error correction code, and other types of additional information. Here, the term ‘frame’ means one still image.

The video stream VS may be data converted into a frame rate according to broadcasting standards. For example, it is assumed that raw data is captured at 30 fps using a camera. Here, the ‘fps’ means frames per second and is a unit of a frame rate.

In order to provide the raw data to a receiver according to the broadcasting standards requesting 60 fps, the raw data should be encoded in a specific compression format and the frame rate of the raw data, i.e., 30 fps, should be converted into 60 fps to efficiently transmit the raw data.

The frame rate of the raw data may be changed into a frame rate different from the frame rate of the raw data after the raw data is encoded in the specific compression format. For example, the encoder may convert a 30 fps video from raw data into a 60 fps video encoded into a format that complies with a specific standard.

That is, in order to comply with the broadcasting standards or the specific compression format, the raw data may be converted into data having a higher frame rate than that of the raw data. The converting of the raw data may be performed mainly according to a pull-down method.

The pull-down method is a method of converting consecutive frames into a specific cadence format. The specific cadence format may be determined based on the ratio between the frame rate of the raw data and a required frame rate, and may be 2:2, 3:2, 2:3:3:2, 2:2:2:4, etc.

For example, when the frame rate of the raw data is 24 fps and the required frame rate is 60 fps, consecutive frames may be converted into a cadence format of 3:2. That is, when an A frame and a B frame are consecutive frames, the A frame may be increased to three frames and the B frame may be increased to two frames.

Methods of increasing the number of frames may include a method of increasing the number of frames by simply repeating each of the frames, a method of increasing the number of frames by dividing the frames into a plurality of line groups and interlacing frames belonging to each of the line groups, etc. For example, the lines from a first frame and lines from a second frame are combined to create frame that is then inserted in between the first frame and the second frame.

The decoding system 10 may include a decoder 100 and a post-processor 200. In one exemplary embodiment, the decoder 100 and the post-processor 200 may be embodied as one chip or two chips. The decoder 100 and the post-processor 200 may be implemented by using a CPU, processor, etc.

The decoder 100 may decode the video stream VS, and generate the original stream by selectively removing at least one duplicate frame from the video stream VS.

The post-processor 200 may post-process the original stream to generate a decoded and processed stream DPS. The decoded and processed stream DPS may be stored in a memory or transmitted to a display device capable of reproducing video.

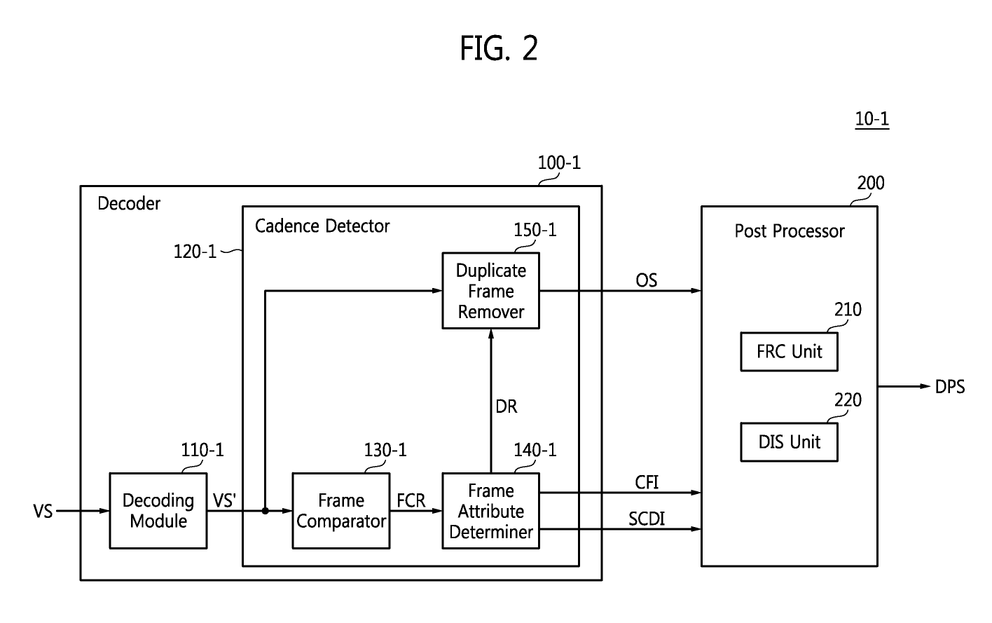

The structures and operations of the decoder 100 and the post-processor 200 will be described in detail with reference to FIGS. 2 to 4 below.

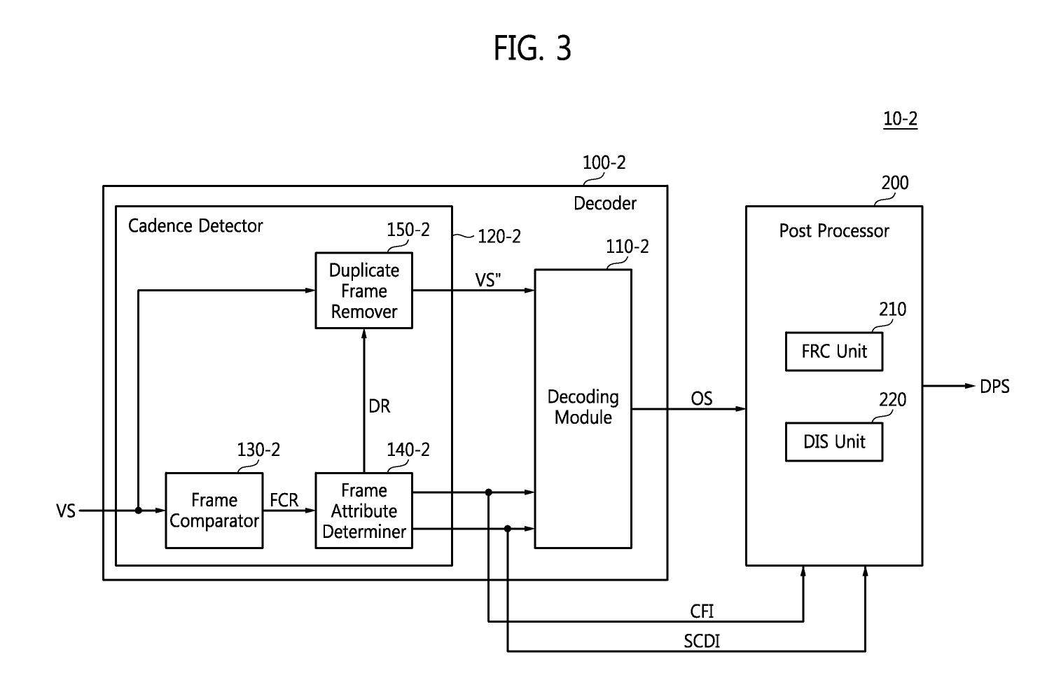

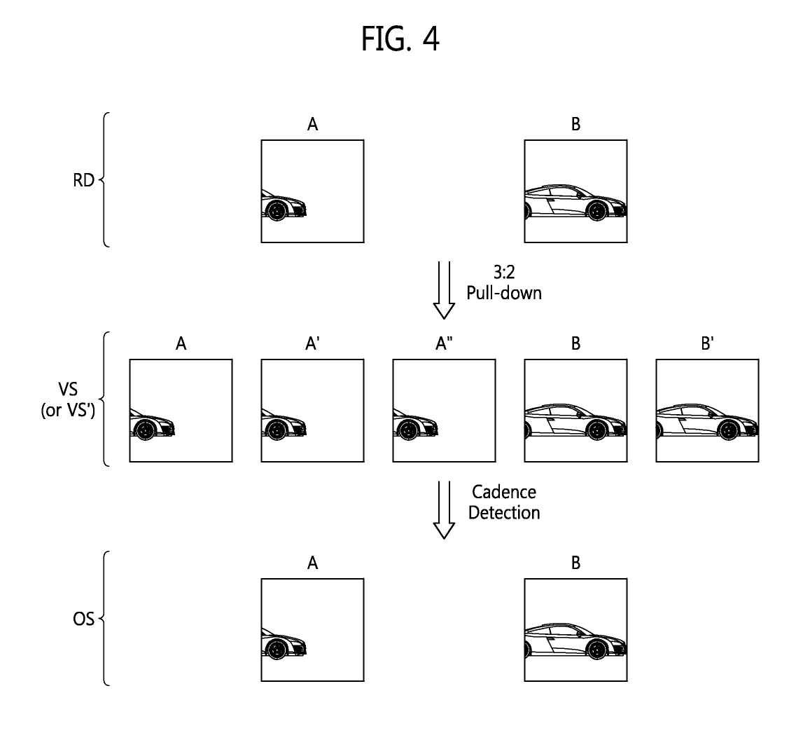

FIG. 2 is a detailed block diagram of a decoding system 10-1 such as the decoding system 10 of FIG. 1 according to an exemplary embodiment. FIG. 3 is a detailed block diagram of a decoding system 10-1 such as the decoding system 10 of FIG. 1 according to another exemplary embodiment. FIG. 4 is a diagram illustrating an operation of the decoding system 10-1 or 10-2 of FIG. 2 or 3 according to an exemplary embodiment.

Referring to FIGS. 1 to 4, the decoding system 10-1 may include a decoder 100-1 and a post-processor 200.

The decoder 100-1 may include a decoding module 110-1 and a cadence detector 120-1.

The decoding module 110-1 may receive the video stream VS and provide output to the cadence detector 120-1 and may decode a video stream VS.

When the video stream VS includes video data encoded in a specific compression format, the decoding of the video stream VS may convert the video stream VS into the original data or the video data that was encoded into the video stream VS.

The cadence detector 120-1 may include a frame comparator 130-1, a frame attribute determiner 140-1, and a duplicate frame remover 150-1.

The frame comparator 130-1 may generate a comparison result FCR by comparing consecutive frames of a video stream VS' decoded by the decoding module 110-1.

As illustrated in FIG. 4, it is assumed that raw data RD includes a frame A and a frame B. When the frame A and the frame B, which are consecutive frames, are converted into a cadence format of 3:2 such that each of the frames A and B are simply repeated, the frame A may be duplicated to three frames, e.g., the frame A and duplicate frames A′ and A″, and the frame B may be duplicated to two frames, e.g., the frame B and a duplicate frame B′. Thus, the frame rate of the video stream VS or the decoded video stream VS' is 2.5 times greater than that of the raw data RD.

The frame comparator 130-1 may generate comparison results FCR by comparing consecutive frames of the decoded video stream VS′, e.g., by comparing the frames A and A′, the frames A′ and A″, the frames A″ and B, and the frames B and B′. The comparison results FCR may be numerical values, e.g., 0 to 100, which represent degrees to which the consecutive frames coincide with each other.

In one exemplary embodiment, a frame buffer may be provided in the frame comparator 130-1 or at a front end of the frame comparator 130-1 to temporarily store the decoded video stream VS' and output different data in units of frames.

The frame attribute determiner 140-1 may determine whether the consecutive frames correspond to a pull-down stream, based on the comparison results FCR, and generate a determination result DR.

For example, the frame attribute determiner 140-1 may compare each of the comparison results FCA obtained by comparing the frames A and A′, the frames A′ and A″, the frames A″ and B, and the frames B and B′ with a predetermined threshold value. The predetermined threshold value may be a boundary value for determining whether the consecutive frames correspond to frames in a pull-down stream, i.e., whether the consecutive frames are substantially the same thereby indicating a pull-down stream.

When the comparison results FCR may be values ranging from 0 to 100 and the threshold value is ‘90’, the comparison results FCA obtained by comparing the frames A and A′, the frames A′ and A″, the frames A″ and B, and the frames B and B′ may be ‘100’, ‘100’, ‘40’, and ‘100’, respectively. The frame attribute determiner 140-1 may determine that all the consecutive frames A and A′, A′ and A″, and B and B′ except for the frames A″ and B are pull-down frames.

Thus, the determination result DR may include information indicating that the second, third, and fifth frames among the consecutive frames A to B′ are duplicate frames in a pull down stream.

The frame attribute determiner 140-1 may generate cadence format information (CFI) regarding a pull-down ratio, based on the determination result DR. For example, raw data of video streams VS' decoded with respect to the same data may have different frame rates, e.g., 24 fps and 30 fps, when one of the video streams VS' was captured indoors and the other was captured outdoors. In this case, the raw data of the video streams VS' may be pulled down to a ratio of 3:2 and a ratio of 2:2, respectively, according to the same broadcasting standards requesting 60 fps.

For example, when a determination result DR indicating that the second, third, and fifth frames among the consecutive frames A to B′ are duplicate frames is repeated and then a determination result DR indicating that the second and fourth frames among the consecutive frames A to B′ are duplicate frames is repeated, the frame attribute determiner 140-1 may determine that a cadence format applied to the decoded video stream VS' is changed from 3:2 to 2:2 and generate cadence format information CFI indicating that the pull-down ratio is changed from 3:2 to 2:2.

The frame attribute determiner 140-1 may generate scene change detection information SCDI indicating a change in the consecutive frames, based on the comparison results FCR.

For example, the consecutive frames A to B′ may form an image of a moving automobile, whereas consecutive frames following the consecutive frames A to B′ may form a close-up image of a human face. In this case, a comparison result FCR obtained by comparing the frame B′ with a consecutive frame following the frame B′ may be ‘10’. The frame attribute determiner 140-1 may compare the comparison result FCR with a predetermined threshold value, e.g., ‘20’, and determine that the consecutive frame corresponds to a change in a scene (e.g., a flash effect, fading in/out, scene overlapping, a sudden scene change, etc.) when the comparison result FCR is less than the threshold value. In contrast, since a comparison result FCR obtained by comparing the consecutive frames A″ and B is ‘40’, the frame attribute determiner 140-1 may determine that the frame B does not correspond to such a change in a scene.

Thus, the scene change detection information SCDI may include information indicating that consecutive frame following the frame B′ corresponds to such a change in a scene.

The duplicate frame remover 150-1 may generate the original stream OS by selectively removing at least one duplicate frame from consecutive frames, based on the determination result DR.

For example, when the determination result DR includes information indicating that the second, third, and fifth frames among the consecutive frames A to B′ are duplicate frames, the duplicate frame remover 150-1 may remove the second, third, and fifth frames among the consecutive frames A to B′ (i.e., the first and fourth frames may remain, based on the determination result DR. That is, referring to FIG. 4, the original stream OS may be generated by removing the second, third, and fifth frames from among the consecutive frames A to B′ through cadence detection

For example, when the determination result DR includes information indicating no duplicate frames are included in the consecutive frames A to B′, the duplicate frame remover 150-1 may bypass the consecutive frames A to B′. This is because high-performance cameras that have been recently developed are capable of generating raw data at a high frame rate, e.g., 60 fps or 120 fps, and thus the raw data may not be pulled down.

The cadence detector 120-1 may transmit the original stream OS, the cadence format information CFI, and the scene change detection information SCDI to the post-processor 200.

The post-processor 200 may post-process the original stream OS. The post-processor 200 may include a frame rate conversion (FRC) unit 210 (e.g., a frame rate converter, etc.) and a digital image stabilization unit (DIS) unit 220 (e.g., a digital image stabilizer, etc.). Here, the FRC unit 210 and the DIS unit 220 are merely examples of elements related to post-processing of a video before the video is displayed, and the post-processor 200 may further include elements for performing other functions, e.g., interlaced-to-progressive (I2P) video converter.

Since the original stream OS is a frame from which duplicate frames are removed by the decoder 100-1, the amount of calculation to be performed by the post-processor 200 (or power consumption in the post-processor 200) may decrease and a transmission bandwidth between the decoder 100-1 and the post-processor 200 may increase.

The FRC unit 210 may convert the original stream OS into a stream having a predetermined frame rate. The converting of the original stream OS into the stream having the predetermined frame rate is performed to form a smoother video, and may be a process of generating an interpolated frame from consecutive frames by using a motion vector or the like and inserting the interpolated frame between the consecutive frames. The predetermined frame rate may be determined by a user or may be a default frame rate that is set in an apparatus in which the decoding system 10 is installed.

For example, when the frame rate of the original stream OS is 60 fps and the predetermined frame rate is 120 fps, the FRC unit 210 may convert the frame rate of the original stream OS into 120 fps by inserting one interpolated frame between every adjacent consecutive frames of the original stream OS.

In this case, when the original stream OS is a stream pulled down to a cadence format of 2:2, i.e., a stream from which duplicate frames are not removed by the cadence detector 120-1, the same frames are repeated in a regular form and thus interpolated frames are substantially the same as these frames. Accordingly, a smoother video cannot be formed by the FRC unit 210.

In contrast, when the original stream OS has a cadence format of 1:1, from which duplicate frames are removed by the cadence detector 120-1, i.e., the original stream OS is a stream that is not pulled down, consecutive frames of the original stream OS are not the same and thus a smoother video may be formed by inserting interpolated frames by the FRC unit 210.

Thus, the decoder 100-1 may be operated to remove duplicate frames from the original stream OS, and thus the FRC unit 210 may convert the original stream OS into a stream to obtain a smoother video.

The FRC unit 210 may detect a change in the frame rate of the original stream OS beforehand, based on the cadence format information CFI regarding a pull-down ratio, and thus decrease unnecessary arithmetic operations and errors when the frame rate of the original stream OS is converted.

For example, when the cadence format information CFI includes information indicating that a pull-down ratio changes from 3:2 to 2:2 after a specific frame, the FRC unit 210 may detect beforehand that the frame rate of the original stream OS changes from 24 fps to 30 fps after the specific frame. Thus, the FRC unit 210 may insert four interpolated frames between consecutive frames and then insert three interpolated frames between consecutive frames after the specific frame so as to convert the frame rate of the original stream OS into 120 fps.

The FRC unit 210 may detect a scene change in the original stream OS beforehand, based on the scene change detection information SCDI regarding a change in consecutive frames, and thus perform only simple operations (e.g., repeating or temporal blending) when the frame rate of the original stream OS is converted, thereby decreasing unnecessary operations and errors.

For example, when the scene change detection information SCDI includes information indicating that a sudden scene change occurs after a specific frame, the FRC unit 210 may perform only a simple operation on consecutive frames following the specific frame.

When the original stream OS may include a shaky video due to camera shaking, the DIS unit 220 may correct the shaky video to be a non-shaky video by stabilizing the images of the video. That is, the DIS unit 220 may determine whether a camera photographing the video was shaking based on motion information of consecutive frames, e.g., information obtained by determining several sub regions in one frame and estimating motion in the sub regions, and correct each frame based on a result of determining whether the camera was shaking.

For example, when the original stream OS is a stream pulled down to a cadence format of 2:2, i.e., a stream from which duplicate frames are not removed by the cadence detector 120-1, same frames that are not present in raw data may repeatedly occur in a regular pattern. Thus, deformed motion information may be generated and the result of the camera shaking may remain in the video or deteriorate the video regardless of an operation of the DIS unit 220.

In contrast, when the original stream OS has a cadence format of 1:1, from which duplicate frames are removed by the cadence detector 120-1, i.e., the original stream OS is a stream that is not pulled down, and same frames do not repeatedly occur in the original stream OS, similar to raw data. Thus, the DIS unit 220 may be thus capable of generating correct motion information and effectively compensating the video for camera shaking.

Accordingly, the decoder 100-1 may remove duplicate frames from the original stream OS, and thus the DIS unit 220 may appropriately correct shaking in videos included in the original stream OS due to camera shaking.

The DIS unit 220 may detect a change in the frame rate of the original state OS beforehand, based on the cadence format information CFI regarding the pull-down ratio, and thus decrease unnecessary operations and errors when the original stream OS is corrected.

For example, when the cadence format information CFI includes information indicating that the pull-down ratio changes from 3:2 to 2:2 after a specific frame, the DIS unit 220 may detect beforehand that the frame rate of the original stream OS will change from 24 fps to 30 fps after the specific frame, and thus control a parameter used for detecting motion information.

The DIS unit 220 may detect a scene change in the original stream OS beforehand, based on the scene change detection information SCDI regarding a change in consecutive frames and may not thus correct the original stream OS, thereby decreasing unnecessary operations and errors.

For example, when the scene change detection information SCDI includes information regarding a sudden scene change occurring after the specific frame, the DIS unit 220 may not correct the specific frame.

Operations of the FRC unit 210 and the DIS 220 included in the post-processor 200 may or may not be performed according to a user's selection or may be performed in parallel or sequentially.

FIG. 3 illustrates a decoding system 10-2 according to another exemplary embodiment. The decoding system 10-2 may include a decoder 100-2 and a post-processor 200.

The decoding system 10-2 is substantially the same as the decoding system 10-1 except for some differences and will be thus described focusing on the differences.

The decoding system 10-2 may include a decoding module 110-2 and a cadence detector 120-2. The decoding module 110-2 may decode an output stream VS″ of the cadence detector 120-2 at a back end of the cadence detector 120-2.

The cadence detector 120-2 may be operated by inputting thereto the original video stream VS that was not decoded rather than the decoded stream VS′.

The frame comparator 130-2 may compare encoded frames rather than decoded frames. That is, in the case of same frames encoded in the same compression format, whether the frames are the same may be determined even when the frames were encoded.

The frame attribute determiner 140-2 may determine whether consecutive frames correspond to a pull-downed stream, based on a comparison result FCR, and thus generate a determination result DR, cadence format information CFI, and scene change detection information SCDI.

The duplicate frame remover 150-2 may generate a stream by selectively removing at least one duplicate frame from consecutive frames, i.e., an output stream VS″ of the cadence detector 120-2, based on the determination result DR. That is, the output stream VS″ of the cadence detector 120-2 corresponds to the video stream VS from which the at least one duplicate frame is selectively removed.

The cadence format information CFI and the scene change detection information SCDI may be transmitted to the post-processor 200 and the decoding module 110-2.

The decoding module 110-2 may decode the output stream VS″ of the cadence detector 120-2 by using the cadence format information CFI and the scene change detection information SCDI. The output stream VS″ of the cadence detector 120-2 corresponds to the video stream VS from which the at least one duplicate frame is selectively removed and thus the amount of calculation to be performed by the decoding module 110-2 may decrease.

The decoding module 110-2 may detect a change in a frame rate or a change in a scene beforehand, based on the cadence format information CFI or the scene change detection information SCDI, and may more efficiently decode the output stream VS″ of the cadence detector 120-2 based on the change in the frame rate or the change in the scene.

Various elements illustrated in FIGS. 1 to 3, e.g., the elements 110-1, 130-1, 140-1, 150-1, 210, and 220, may be embodied as software, hardware, or a combination of software and hardware. In particular, although not shown, the decoding systems 10, 10-1, and 10-2 may include a central processing unit (CPU), processor and/or a memory to perform the functions of the elements illustrated in FIGS. 1 to 3.

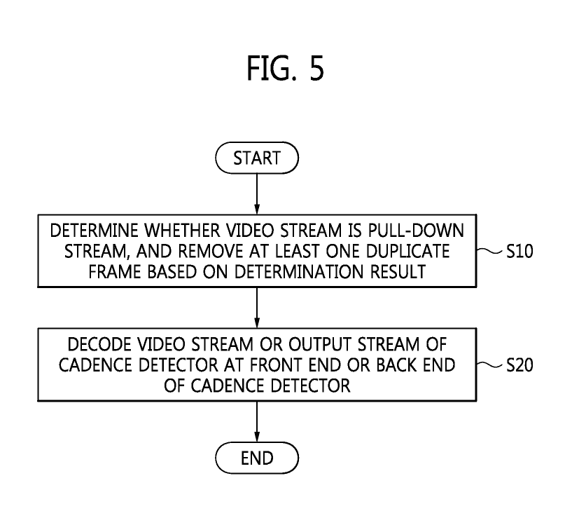

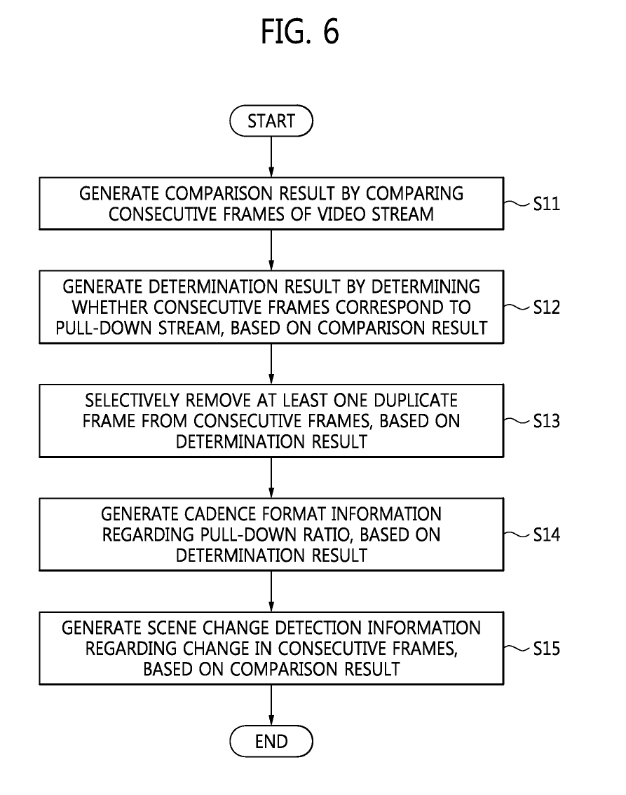

FIG. 5 is a flowchart of a method of operating the decoder 100 of FIG. 1 according to an exemplary embodiment. FIG. 6 is a detailed flowchart of an operation of the cadence detector 120-1 or 120-2 of FIG. 2 or 3 according to an exemplary embodiment.

Referring to FIGS. 1 to 6, the cadence detector 120-1 or 120-2 may generate a determination result DR by determining whether a decoded video stream VS' or a video stream VS is a pull-down stream, and remove at least one duplicate frame from the decoded video stream VS' or the video stream VS, based on the determination result DR (operation S10).

The decoding module 110-1 or 110-2 may decode the video stream VS at the front end of the cadence detector 120-1 (see FIG. 2) or decode an output stream VS″ of the cadence detector 120-2 at the back end of the cadence detector 120-2 (see FIG. 3) (operation S20).

Operation S10 may include operations S11 to S15.

The frame comparator 130-1 or 130-2 may generate a comparison result FCR by comparing consecutive frames of either the video stream VS' decoded by the decoding module 110-1 or consecutive frames of the video stream VS (operation S11).

The frame attribute determiner 140-1 or 140-2 may determine whether the consecutive frames correspond to a pull-down stream, based on the comparison result FCR, and generate a determination result DR (operation S12).

The duplicate frame remover 150-1 or 150-2 may generate the original stream OS or an output stream VS″ by selectively removing at least one duplicate frame from the consecutive frames, based on the determination result DR (operation S13).

The frame attribute determiner 140-1 or 140-2 may generate cadence format information CFI regarding a pull-down ratio, based on the determination result DR (operation S14).

The frame attribute determiner 140-1 or 140-2 may generate scene change detection information SCDI regarding a change in the consecutive frames, based on the comparison result FCR (operation S15).

In a decoder, an application processor including the decoder, and a method of operating the decoder according to an exemplary embodiment, duplicate frames are removed from a pull-down video stream to minimize power consumption in the decoder and a post-processor, and to minimize the amount of calculation, and errors.

Exemplary embodiments may also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices.

The computer-readable recording medium can also be distributed over network coupled computer systems so that the computer-readable code is stored and executed in a distributed fashion. Functional programs, codes, and code segments to accomplish the exemplary embodiments may be implemented by programmers.

While the inventive concept has been particularly shown and described with reference to exemplary embodiments thereof, it will be understood that various changes in form and details may be made therein without departing from the spirit and scope of the following claims.

1. A decoder comprising:
a cadence detector configured to determine whether a video stream is a pull-down stream, and remove at least one duplicate frame from the video stream, in response to the determining that the video stream is the pull-down stream;
a decoding module configured to decode the video stream and output decoded frames of the video stream; and
a post-processor configured to post-process the decoded frames from which the at least one duplicate frame is removed.

2. The decoder of claim 1, wherein the cadence detector comprises:
a frame comparator configured to determine that consecutive frames of the video stream are duplicate frames;
a frame attribute determiner configured to determine that the video stream corresponds to the pull-down stream, based on a determination result of the frame comparator; and
a duplicate frame remover configured to remove the at least one duplicate frame from the video stream, based on a determination result of the frame attribute determiner.

3. The decoder of claim 2, wherein the duplicate frame remover bypasses the consecutive frames when the consecutive frames do not include the at least one duplicate frame.

4. The decoder of claim 2, wherein the frame attribute determiner generates cadence format information indicating a pull-down ratio if the video stream is the pull-down stream, based on the determination result of the frame comparator.

5. The decoder of claim 2, wherein the frame attribute determiner generates scene change detection information indicating a change of a scene in the consecutive frames, based on the determination result of the frame comparator.

6. The decoder of claim 1, wherein, in response to the decoding module decoding the video stream, the cadence detector is configured to output, to the post-processor, the original stream, cadence format information indicating a pull-down ratio of the video stream, and scene change detection information indicating a change of a scene in consecutive frames of the video stream.

7. The decoder of claim 1, wherein, in response to the decoding module decoding the video stream, the cadence detector is configured to output cadence format information indicating a pull-down ratio and scene change detection information indicating a change of a scene in consecutive frames of the video stream, and
wherein the decoding module is configured to decode the video stream based on the cadence format information and the scene change detection information.

8. An application processor comprising:
a decoder configured to decode a pull-down video stream and generate a decoded video stream from which at least one duplicate frame is removed; and
a post-processor configured to post-process the decoded video stream,
wherein the post-processor comprises:
a frame rate conversion unit configured to convert the decoded video stream into a video stream having a predetermined frame rate; and
a digital image stabilization unit configured to perform image stabilization on the decoded video stream having the pre-determined frame rate.

9. The application processor of claim 8, wherein the decoder comprises:
a cadence detector configured to determine whether a video stream is the pull-down stream, and to remove the at least one duplicate frame from the video stream, in response to determining that the video stream is the pull-down stream; and
a decoding module configured to decode the pull-down video stream and output decoded frames of the video stream.

10. The application processor of claim 9, wherein the cadence detector comprises:
a frame comparator configured to determine that consecutive frames of the video stream are duplicate frames;
a frame attribute determiner configured to determine that the video stream corresponds to the pull-down stream, based on a determination result of the frame comparator; and
a duplicate frame remover configured to remove the at least one duplicate frame from the video stream, based on a determination result of the frame attribute determiner.

11. The application processor of claim 10, wherein the duplicate frame remover bypasses the consecutive frames when the consecutive frames do not include the at least one duplicate frame.

12. The application processor of claim 10, wherein the frame attribute determiner generates cadence format information indicating a pull-down ratio if the video stream is the pull-down stream, based on the determination result of the frame comparator.

13. The application processor of claim 10, wherein the frame attribute determiner generates scene change detection information indicating a change of a scene in the consecutive frames, based on the determination result of the frame comparator.

14. The application processor of claim 9, wherein, in response to the decoding module decoding the video stream, the cadence detector is configured to output, to the post-processor, the original stream, cadence format information indicating a pull-down ratio of the video stream, and scene change detection information indicating a change of a scene in consecutive frames of the video stream.

15. The application processor of claim 9, wherein, in response to the decoding module decoding the video stream, the cadence detector is configured to output cadence format information indicating a pull-down ratio and scene change detection information indicating a change of a scene in consecutive frames of the video stream, and
wherein the decoding module is configured to decode the pull-down video stream, based on the cadence format information and the scene change detection information, and output, to the post-processor, the decoded stream obtained by decoding the pull-down video stream.

16-19. (canceled)

20. A decoder comprising:
a cadence detector comprising a frame comparator, a frame attribute determiner, and a duplicate frame remover; and
a decoding module configured to decode a video stream,
wherein:
the frame comparator is configured to generate a comparison result by comparing consecutive frames of the video stream with each other;
the frame attribute determiner is configured to generate a determination result by determining whether the consecutive frames correspond to the pull-down stream, based on the comparison result; and
the duplicate frame remover is configured to selectively remove the at least one duplicate frame from the consecutive frames, based on the determination result.

21. The decoder of claim 20, wherein the duplicate frame remover bypasses the consecutive frames when the consecutive frames do not include the at least one duplicate frame.

22. The decoder of claim 20, wherein the frame attribute determiner generates cadence format information about a pull-down ratio, based on the determination result.

23. The decoder of claim 20, wherein the frame attribute determiner generates scene change detection information about a change of a scene in the consecutive frames, based on the comparison result.
